(19) United States
(12) Patent Application Publication
(10) Pub. No.: US 2006/0141416 A1
(43) Pub. Date: Jun. 29, 2006

(54) Occlusal indicator tray & processes therefor

(76) Inventor: Eric J. Knutson, Granite Bay, CA (US)

Correspondence Address: Eric J. Knutson, 5815 Granite Hills Drive, Granite Bay, CA, 95746, US

(21) Appl. No.: 11/025,649

(22) Filed: Dec. 24, 2004

(51) Int. Cl. A61C 9/00

(52) U.S. Cl. 433/37; 433/71

(57) ABSTRACT

Material and methods for constructing custom dental trays quickly and inexpensively, especially dental trays which are useful for the detection, evaluation, and treatment of mandibular parafunction. A manufactured dental tray material includes occlusal pressure indicators, and can include electronics for storing and analyzing occlusal pressures.

### BACKGROUND

1. Field of Invention

This invention relates to dental trays, specifically to dental trays that indicate pressure from occlusal contact.

2. Occlusal Treatment

Splints, stents, and night guards are types of dental appliances which have been fitted with sensors to indicate pressure from occlusal contact. Generally, such appliances are fairly costly and time consuming to fabricate, and are made by a dental laboratory. They are useful for collecting data on dental occlusion, jaw muscle activity during sleep, and so on. Such appliances are primarily used to diagnose or treat patients exhibiting high levels of activity in the muscles of mastication during various stages of sleep, known as bruxism, or mandibular parafunction. Patients generally take such appliances to their homes, and wear them in the mouth during sleep, typically accompanied by one or more data collection or analysis devices. Generally, patients who receive treatment with these appliances are symptomatic, and are well aware that they have an advanced problem that needs treatment.

In contrast, there is a large group of people who are unaware that they have a problem that needs treatment. Many people exhibit moderate levels of parafunction, but do not have sufficient symptoms to cause them to believe they need treatment. They are predominantly unaware that they are slowly chipping or wearing away their teeth, slowly spreading fractures through their teeth, weakening exisiting dental restorations, traumatizing the alveolar bone around the teeth, traumatizing their temporomandibular joints, or causing headaches. They tend to become aware of these problems only when they have unnecessarily progressed to obvious symptoms, have lost function or structure, and need more costly treatment.

Sleep research shows that approximately half of the general population could benefit from use of a simple hard night guard. Generally, hard night guards are made by a dental laboratory, are time consuming to fabricate, require multiple office visits to fit, and are somewhat costly for patients. Therefore, patients must somehow become aware that they could benefit from the use of a night guard before they will want to proceed with night guard fabrication.

Dental practitioners are able to rapidly assess signs of parafunction, such as linea alba, serrated tongue, TMJ irregularities, dental attrition, vertical bone loss, and so on. However, even if time is taken to show patients these signs, they remain relatively meaningless to them. A practitioner can spend significant time describing the sequelae of these problems to patients, but patients are generally not motivated to treat problems that they see little or no direct evidence of. Dental practitioners therefore have the undesirable task of being obligated to inform patients that they need a somewhat costly night guard to prevent a problem the patient is not sure they have. Therefore, dental practitioners need of a rapid, low cost means to help patients realize that parafunction is indeed occurring.

3. Description of Prior Art

Custom trays are trays which are designed to custom fit over at least a portion of a person's teeth. Custom trays generally fit with a greater accuracy of adaptation to the form of the teeth than stock trays. Custom trays are used in dentistry for performing various functions in the mouth. These functions include impression material carrier, bruxism protection, athletic guard, airway maintenance, surgical stents, medicament carrier, and so on. Medicaments to be carried in custom trays include tooth whitening agents, anticariogenic agents, antibacterial agents, desensitizing agents, and so on. In contrast to the laboratory fabricated splints, stents and night guards with occlusal pressure indicators, custom trays are generally made in a dental office.

In one common process for forming custom dental trays, the steps include taking impressions of the teeth, pouring plaster into the impressions to form plaster models of the teeth, providing a manufactured square-cut or round-cut thin sheet of custom tray material, said sheet having a specified uniform thickness, heating said sheet of dental tray material until it is moldable, applying a vacuum source to the moldable dental tray material to mold it to the form of the plaster model, allowing the moldable tray material to cool until it becomes non-moldable tray material, and trimming the non-moldable tray material to form a dental tray. Trays made with this process are accurately conformed to the teeth.

The vacuum source used in the above process is typically a specialized vacuum pump of moderate cost. Therefore this method of forming custom trays is performed in dental offices or dental laboratories by skilled personnel. In addition, while forming custom trays using this process can be accomplished in a single patient visit, it is more common for an additional patient visit to be made to deliver the completed trays, due to the amount of time required to complete the trays. Trays formed with this process tend to be accurately conformed to the teeth, have good retention to the teeth, and have a low rate of fluid leakage.

In a second process for forming custom dental trays, a low melting point polymer tray material is heated until moldable, and then molded intraorally to conform it to the form of the teeth. The process for molding the tray material intraorally include instructing the patient to bite down lightly, push the tongue against the roof of the mouth, suck air and water out of their mouth, conform the tray material to the shape of the teeth with fingers, then remove and hold under cold water. The custom tray material and process is intended to reduce the time required to form a custom dental tray. It is also intended to permit the formation of a custom dental tray without the need for costly specialized vacuum equipment, or skilled dental office personnel. Such custom dental trays could be constructed rapidly by dental office personnel, or could be constructed by the public at home. However, trays made with this process tend to be less accurately conformed to the teeth.

In a third process for forming custom dental trays, there is provided a thin pliable inner sheet of tray material nested in an outer thicker dental tray. The pliable inner tray is pre-loaded with a medicament, such as a sticky whitening gel. The thicker tray is used to seat the pliable inner tray on the dental arch, and is then discarded. The pliable inner tray is adhered to the teeth via the sticky medicament, and is finger-molded to enhance adaptation to the teeth. The moldability of the pliable inner tray material is not substantially altered during this process.

In a fourth process for forming custom dental trays, a pliable tray is pre-loaded with a sticky medicament. The pliable tray is adhered to the teeth via the sticky medicament, and is finger molded to enhance adaptation to the teeth. The moldability of the pliable tray material is not substantially altered during this process.

The above processes for forming custom dental trays suffer from a number of disadvantages:

(a) Accurately adapted trays require skilled personnel
(b) Accurately adapted trays require costly specialized equipment
(c) Accurately adapted trays can require substantial time
(d) Trays formed are not capable of indicating occlusal pressure
(e) Trays formed intraorally tend to have poor adaptation to the teeth
(f) Trays formed intraorally tend to have poor retention to the teeth
(g) Trays formed intraorally tend to have substantial fluid leakage

A tray material and process similar to my custom dental tray material and process would not have been as practical prior to the development of low melting polymers, or other materials which are moldable at temperatures which are tolerated intraorally, and then can be caused to become substantially non-moldable.

### SUMMARY OF THE INVENTION

The present invention is directed to fabricating custom dental trays quickly and inexpensively, such as by forming custom dental trays intraorally, and especially to forming custom dental trays which can indicate occlusal contact pressure. Custom trays which can indicate occlusal contact pressure can be useful for the detection, evaluation, and treatment of mandibular parafunction.

The invention provides a first process for forming dental custom trays wherein an imprint is made of a person's teeth, a moldable sheet of tray material is interposed between the teeth and the imprint, and the imprint is forcefully seated onto the teeth and tray material, thereby molding said tray material.

The invention provides a second process for forming dental custom trays wherein a moldable sheet of tray material is interposed between the teeth and a moldable material in a pliable container, and said moldable material is forcefully seated onto the teeth and said tray material, thereby molding said tray material.

The invention provides a third process for forming dental custom trays wherein a moldable sheet of tray material, having a vacuum tube about the perimeter, is seated over the teeth, and a vacuum is introduced into said vacuum tube, said vacuum having the effect of drawing said moldable sheet of tray material onto the surfaces of the teeth, thereby molding said tray material.

The invention also provides a sheet of custom dental tray material having occlusal pressure indicators, for use in the processes thereof.

The invention also provides a sheet of custom dental tray material having a connector for attaching said tray material to a dental imprint, to a moldable material in a pliable container, or to a dental tray.

The invention also provides a dental tray which contains a moldable material, wherein at least a portion of said tray is pliable. Said tray is used to provide pressure to mold custom tray material intraorally.

The invention also provides a dental tray having a surface which faces the opposing arch of teeth, wherein said surface has a configuration and consistency such that the force with which the opposing arch of teeth can be occluded against said surface is maximized, thereby permitting increased seating pressure of said tray onto the teeth.

### DETAILED DESCRIPTION OF PROCESSES

According to one aspect of the invention, there is provided a first process for forming dental trays comprising the steps of: making an imprint of a person's teeth with a moldable space filling material, causing said moldable space filling material to be substantially non-moldable, forming a non-moldable space filling material, providing a moldable tray material wherein at least a portion of said moldable tray material is a sheet, interposing said moldable tray material between said non-moldable space filling material and the teeth, forcefully seating said non-moldable space filling material over said moldable tray material such that said moldable tray material becomes molded to fit the shapes of the teeth, causing said moldable tray material to become substantially non-moldable, and thereby forming a molded tray material, removing said non-moldable space filling material and said molded tray material from the teeth, removing said molded tray material from said non-moldable space filling material, and trimming said molded tray material to form a custom dental tray.

It is preferred that said sheet of moldable tray material is embedded with a pressure indicator, such that when a custom dental tray comprised of said moldable tray material is inserted between forcefully occluding dental arches, and the occlusal contacts of the teeth forcefully press against portions of said custom dental tray, then a record is produced on said custom dental tray. Said record therefore can serve as an indicator that records the location, duration, amplitude or times of occlusal pressure upon said custom dental tray.

It is preferred that said non-moldable space filling material is a substantially accurate dental impression material, such as polyvinylsiloxane, or other suitable dental impression materials. However, said non-moldable impression may be made with materials which produce impressions having reduced accuracy and detail, such as impressions made with some details of the teeth partly blocked out with a blockout material, thermoplastic vinyls, or other suitable materials.

It is preferred that said moldable tray material is mounted over said non-moldable space filling material prior to interposing said moldable tray material between said non-moldable space filling material and a person's teeth. It is further preferred that said moldable tray material is made to be moldable after mounting said moldable tray material to said non-moldable space filling material.

It is preferred that said moldable tray material is mounted to said non-moldable space filling material using connectors which detachably connect said moldable tray material to said non-moldable space filling material. However, said moldable tray material may be mounted to said non-moldable space filling material without use of said connectors, or may be placed directly onto the teeth prior to seating said non-moldable space filling material over the teeth.

It is further preferred that said moldable tray material is caused to be moldable by the operator immersing a dental tray material in warm water, such as by immersing a low-melting thermoplastic sheet of dental tray material into water warmed to a specified temperature within the approximate range of 40° to 85° C. As such, the low-melting thermoplastic tray material becomes moldable at a sufficiently low temperature to be tolerated in the mouth. However, said moldable tray material may be made to be moldable by the operator by other means, such as by exposing a dental tray material to chemicals, gasses, radiation, and so on, or said moldable tray material may be moldable as provided from the manufacturer.

It is preferred that a negative pressure vacuum is caused in a vacuum tube, said tube connected to at least a portion of the perimeter of said moldable sheet, said tube having a permeable portion, such that undesirable air and fluids may be removed from between said tray material and the teeth and gingiva, and such that said moldable sheet is drawn toward the teeth and becomes molded to fit the shapes of the teeth.

It is preferred that said moldable tray material be made to be non-moldable by cooling at least to body temperature. However, said moldable tray material can be made to be non-moldable by allowing time to elapse, or by exposing said moldable tray material to oxygen, saliva, chemicals, gasses, radiation, and so on.

It is preferred that said custom tray is molded to fit as closely to the shape of the teeth as possible. However, said custom tray may be molded with a space reserved for an attachment, such as an occlusal pressure sensor. In addition, because said custom trays may be readily fabricated by persons unskilled in the art, said custom tray may be molded with a space reserved for an oral decoration, or for an attachment thereof, such as by temporarily adhering an oral decoration, or similarly shaped spacer thereof, to the teeth or gingiva prior to interposing said moldable tray material between said non-moldable space filling material and the teeth.

According to another aspect of the invention, there is provided a second process for forming dental trays comprising the steps of: providing a moldable tray material wherein at least a portion of said moldable tray material is a sheet, providing a substantially moldable space filling material, interposing said moldable tray material between said moldable space filling material and a person's teeth, forcefully seating said moldable space filling material over said moldable tray material such that said moldable tray material becomes molded to fit the shapes of the teeth, causing said moldable tray material to become substantially non-moldable to form a custom dental tray.

It is preferred that said custom dental tray is removed from the teeth and trimmed to form a trimmed custom dental tray. However, said custom dental tray may remain in the mouth, and remain untrimmed, such as when applying a medicament to the teeth, said medicament being placed on said moldable tray material prior to interposing said moldable tray material between said moldable space filling material and a person's teeth.

It is preferred that said moldable space filling material is not heated during the process. However, said moldable space filling material may be heated during the process. Further, said moldable space filling material may be heated to affect the viscosity of said moldable space filling material, to affect the chemical reactivity of said moldable space filling material with itself, with said moldable tray material, with a medicament carried by said moldable tray material or said custom dental tray, and with the teeth or gingiva, such as when said moldable tray material or said custom dental tray material is permeable, and so on.

It is preferred that said moldable space filling material is not caused to be non-moldable after said moldable tray material becomes molded to fit the shapes of the teeth. However, said moldable space filling material may be caused to be non-moldable after said moldable tray material becomes molded to fit the shapes of the teeth.

It is preferred that said moldable space filling material is contained within a sealed container, said container comprising at least a portion which is substantially pliable. It is preferred that said portion of said container which is substantially pliable is comprised of said moldable tray material. However, said portion which is substantially pliable may be comprised of a material which is separate and distinct from said moldable tray material.

It is preferred that said sheet of moldable tray material is embedded with a pressure indicator, such that when a custom dental tray comprised of said moldable tray material is inserted between forcefully occluding dental arches, and the occlusal contacts of the teeth forcefully press against portions of said custom dental tray, then a record is produced on said custom dental tray. Said record therefore can serve as an indicator that records the location, duration, amplitude or times of occlusal pressure upon said custom dental tray.

It is further preferred that said moldable tray material is caused to be moldable by the operator immersing a dental tray material in warm water, such as by immersing a low-melting thermoplastic sheet of dental tray material into water warmed to a specified temperature within the approximate range of 40° to 85° C. As such, the low-melting thermoplastic tray material becomes moldable at a sufficiently low temperature to be well tolerated in the mouth. However, said moldable tray material may be made to be moldable by the operator by other means, such as by exposing a dental tray material to chemicals, gasses, radiation, and so on, or said moldable tray material may be moldable as provided from the manufacturer.

It is preferred that a negative pressure vacuum is caused in a vacuum tube, said tube connected to at least a portion of the perimeter of said moldable sheet, said tube having a permeable portion, such that undesirable air and fluids may be removed from between said tray material and the teeth and gingiva, and such that said moldable sheet is drawn toward the teeth and becomes molded to fit the shapes of the teeth.

It is preferred that said moldable tray material be made to be non-moldable by cooling at least to body temperature. However, said moldable tray material can be made to be non-moldable by allowing time to elapse, or by exposing said moldable tray material to oxygen, saliva, chemicals, gasses, radiation, and so on.

It is preferred that said custom tray is molded to fit as closely to the shape of the teeth as possible. However, said custom tray may be molded with a space reserved for an attachment, such as an occlusal pressure sensor. In addition, because said custom trays may be readily fabricated by persons unskilled in the art, said custom tray may be molded with a space reserved for an oral decoration, or an attachment for an oral decoration, such as by temporarily adhering an oral decoration, or similarly shaped spacer thereof, to the teeth or gingiva prior to interposing said moldable tray material between said non-moldable space filling material and the teeth.

According to yet another aspect of the invention, there is provided a third process for forming dental trays comprising the steps of: providing a tray material wherein at least a portion of said tray material comprises a moldable sheet, said moldable sheet having a vacuum tube connected to at least a portion of the perimeter thereof, wherein at least a portion of said vacuum tube is permeable, seating said tray material over a person's teeth, causing a negative pressure vacuum in said tube such that undesirable air and fluids may be removed from between said tray material and the teeth and gingiva, and such that said moldable sheet is drawn toward the teeth and becomes molded to fit the shapes of the teeth, causing said moldable sheet to be substantially non-moldable to form a molded sheet, removing said molded sheet from the teeth, and trimming said molded sheet to form a custom dental tray.

It is preferred that a space filling material is forcefully seated over said moldable sheet when said moldable sheet is seated over the teeth, such that said moldable sheet is further molded to fit the shapes of the teeth. However, said moldable sheet may be vacuum-molded to fit the shapes of the teeth without seating said space filling material.

It is preferred that said moldable sheet of tray material is embedded with a pressure indicator, such that when a custom dental tray comprised of said moldable tray material is inserted between forcefully occluding dental arches, and the occlusal contacts of the teeth forcefully press against portions of said custom dental tray, then a record is produced on said custom dental tray. Said record therefore can serve as an indicator that records the location, duration, amplitude or times of occlusal pressure upon said custom dental tray.

It is further preferred that said moldable tray material is caused to be moldable by the operator immersing a dental tray material in warm water, such as by immersing a low-melting thermoplastic sheet of dental tray material into water warmed to a specified temperature within the approximate range of 40° to 85° C. As such, the low-melting thermoplastic tray material becomes moldable at a sufficiently low temperature to be well tolerated in the mouth. However, said moldable tray material may be made to be moldable by the operator by other means, such as by exposing a dental tray material to chemicals, gasses, radiation, and so on, or said moldable tray material may be moldable as provided from the manufacturer.

It is preferred that said moldable tray material be made to be non-moldable by cooling at least to body temperature. However, said moldable tray material can be made to be non-moldable by allowing time to elapse, or by exposing said moldable tray material to oxygen, saliva, chemicals, gasses, radiation, and so on.

It is preferred that said custom tray is molded to fit as closely to the shape of the teeth as possible. However, said custom tray may be molded with a space reserved for an attachment, such as an occlusal pressure sensor. In addition, because said custom trays may be readily fabricated by persons unskilled in the art, said custom tray may be molded with a space reserved for an oral decoration, or an attachment for an oral decoration, such as by temporarily adhering an oral decoration, or similarly shaped spacer thereof, to the teeth or gingiva prior to seating said moldable tray material over a person's teeth.

### OBJECTS AND ADVANTAGES

Accordingly, several objects and advantages of my invention and process are to facilitate the formation of accurately adapted custom dental trays:
(a) by persons unskilled in the art without the use of costly equipment
(b) in a short time
(c) which can indicate occlusal contact pressure
(d) which have low fluid leakage
(e) which have substantial retention to the teeth
(f) by persons unskilled in the art in order to retain attachments

Further objects and advantages are to provide a custom dental tray which can by made by persons of the general public. Still further objects and advantages will become apparent from a consideration of the ensuing description and drawings.

### DRAWING FIGURES

In the drawings, closely related figures have the same number, but different alphabetic suffixes.

FIG. 1 shows a perspective view of an unmolded dental tray material connected to a vacuum source, and ready for mounting on a tray. The tray is filled with a molded space filling material.

FIG. 2 shows a perspective view of an unmolded dental tray material connected to a vacuum source, and mounted on a tray. The tray is filled with a molded space filling material.

FIG. 3 shows a perspective view of a molded dental tray material connected to a vacuum source, and mounted on a tray. The tray is filled with a molded space filling material.

FIG. 4 shows a cross-sectional view of an unmolded dental tray material connected to a tray, said tray being filled with a moldable space filling material.

FIG. 5 shows a perspective view of a tray covered with an unmolded dental tray material. The unmolded dental tray material is shown cutaway to show a moldable space filling material in the tray, and is shown connected to a vacuum source. An electrical connector is shown at the anterior of the tray.

FIG. 6 shows a cross-sectional view of a tray with a pliable cover containing a moldable space filling material.

FIG. 7 shows a perspective view of an arch-shaped pliable cover which contains a moldable space filling material, and is seated into a tray. A cutaway shows said moldable space filling material.

FIG. 8 shows a perspective view of a dental tray with an occlusion wedge and finger rests.

FIG. 9 shows a perspective view of an unmolded dental tray material having a handle, and is connected to a vacuum source. A cutaway shows a frame about the perimeter that is at least partly rigid.

FIG. 10 is an enlarged perspective cutaway view of unmolded dental tray material having pressure indicator.

FIG. 11 shows a perspective view of a formed custom dental tray that has recorded occlusal contact pressures.

FIG. 12 shows a top view of an unmolded custom tray material having multiple pressure indicators connected by circuitry to an electronic chip.

FIG. 13 shows a front view of a custom dental tray retaining attachments, specifically, oral decorations, including lights, tooth facings, costume jewelry, and false teeth.

Reference Numerals in Drawings

| | | | |
|---|---|---|---|
| 20 | sheet | 22 | connector |
| 24 | tray | 26 | non-moldable filler |
| 28 | border | 30 | ports |
| 32 | extension | 34 | valve |
| 36 | vacuum | 38 | moldable filler |
| 40 | pad | 42 | socket |
| 44 | skin | 46 | rest |
| 48 | notch | 50 | frame |
| 52 | handle | 54 | indicator |
| 56 | custom tray | 58 | record |
| 60 | circuit | 62 | chip |
| 64A-F | attachments | | |

### DESCRIPTION

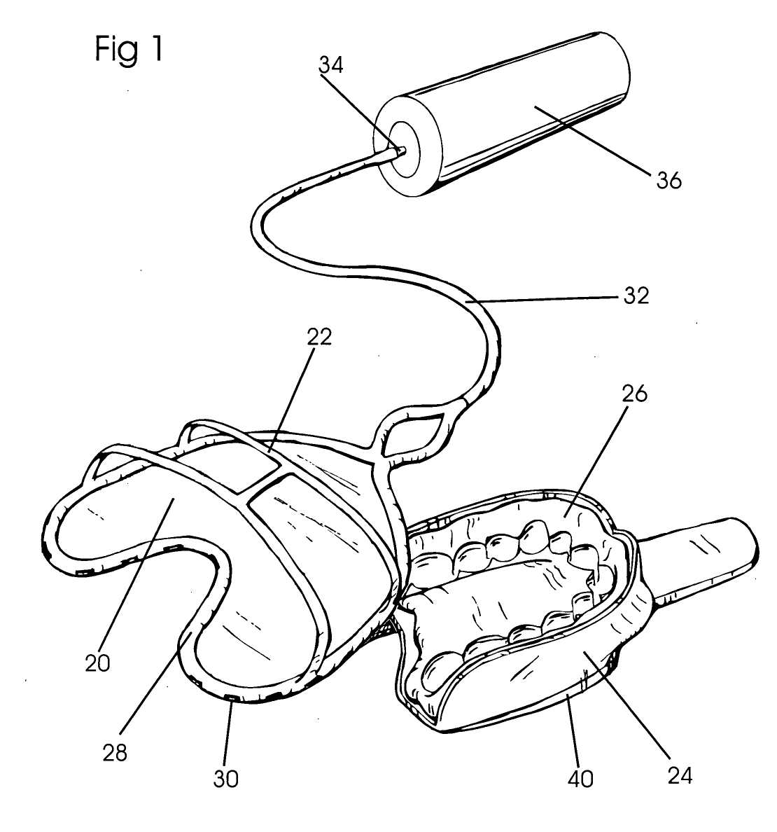

### FIGS. 1 to 13

According to another aspect of the invention, there is provided a tray material for use in the process of the invention, a typical embodiment of which is shown in FIG. 1. Said tray material is comprised of a sheet of material, sheet 20, which can be caused to be plastically deformable, or substantially moldable, and can subsequently be caused to be substantially non-moldable.

It is preferred that sheet 20 is comprised of a material that can be caused to be substantially moldable by the operator during process of the present invention. However, sheet 20 may be provided substantially moldable by the manufacturer of sheet 20, or may be caused to be substantially moldable by the operator prior to the process of the present invention.

It is preferred that the size dimensions of sheet 20 are sufficient to substantially cover an entire arch of teeth. However, sheet 20 may be sized to cover only a portion of an arch of teeth.

It is preferred that the surface of sheet 20 is non-textured. However, the surface of sheet 20 may be textured, such as to improve retention of an oral medicament, or to influence the rate of delivery of an oral medicament.

It is preferred that sheet 20 material is associated with a pressure indicator, such that when a custom dental tray comprised of said moldable tray material is inserted between forcefully occluding dental arches, and the occlusal contacts of the teeth exert occlusal pressure against portions of said custom dental tray, then a record of said occlusal pressure is produced. Said record may be a change in said pressure indicator itself, or may be a signal sent to a recorder, such as an electronic chip. Said record therefore can serve as an indicator that records the location of occlusal pressure areas upon said custom dental tray.

It is preferred that sheet 20 is connected to at least one connector, connector 22, such that connector 22 is a means for detachably connecting sheet 20 to a dental tray, tray 24, or to a material contained within tray 24, such as non-moldable filler 26. It is further preferred that connector 22 is comprised of the same material as sheet 20, such that connector 22 is an extension of sheet 20 material. However, connector 22 may be comprised of clips, snaps, wires, elastics, and so on.

It is preferred that an enlarged border, border 28, is connected to at least a portion of the perimeter of sheet 20, border 28 being comprised of a flexible material, such that border 28 is adaptable to fit the configuration of the oral vestibules about an arch of teeth, such that fluids and air are inhibited from passing border 28.

It is further preferred that border 28 is comprised of a material which will not be substantially moldable when sheet 20 is moldable. However, border 28 may be comprised of a material which can be caused to be moldable when sheet 20 is moldable.

It is further preferred that border 28 is comprised of a vacuum tube having a wall which surrounds a lumen, wherein at least a portion of said wall is permeable, forming a permeable portion, such that undesirable air and fluids may be drawn through said permeable portion and into said lumen of border 28, such that undesirable air and fluids may be removed from between sheet 20 and the teeth and gingiva, and such that sheet 20 is drawn toward the teeth to become molded to fit the shapes of the teeth.

It is further preferred that said permeable portion is comprised of a multiplicity of distinct openings, ports 30, spaced at regular intervals along a portion of the length of border 18. However, said permeable portion may be comprised of small irregular pores within foam, or within an area of porous membrane, and so on.

It is preferred that a tube having a lumen, extension 32, connects to border 28, such that the respective lumens are continuous across the connection. It is further preferred that extension 32 detachably connects to a valve 34, wherein valve 34 is able to regulate the flow of gasses and fluids, valve 34 further connected to a source of negative air pressure, vacuum 36, wherein vacuum 36 can suction fluids and air through extension 32, border 28, and ports 30.

It is preferred that vacuum 36 is an economical valved container substantially evacuated of gasses. However, vacuum 36 may be a manual vacuum pump, or a powered vacuum pump.

Tray 24 is shown filled with a material, non-moldable filler 26. Non-moldable filler 26 is shown having been molded to fit the shapes of the teeth, thereby forming an impression of the teeth. However, tray 24 may contain other materials, such as moldable fillers.

It is preferred that non-moldable filler 26 material is comprised of a mixture from a two part, base-catalyst putty system, such that it is easily preparable by unskilled operators using simple hand mixing. However, non-moldable filler 26 material may be comprised of base-catalyst paste or mousse, thermoplastic, light-cured impression materials, and so on.

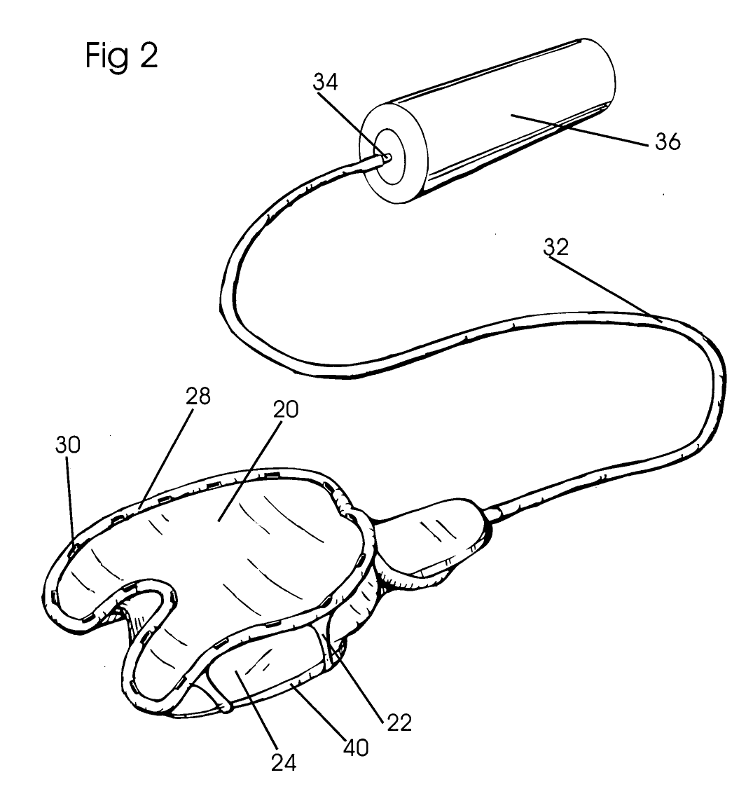

FIG. 2 shows sheet 20 detachably connected to tray 24 and non-moldable filler 26 by means of connector 22, wherein connector 22 stabilizes the position of sheet 20 over non-moldable filler 26 and tray 24. Sheet 20 is shown having been caused to be moldable, such as by immersing in a heated water bath, and is ready for insertion into the mouth, and for seating onto a dental arch. Ports 30 are visible along border 28. Extension 32 is connected to valve 34, and thence to vacuum 36.

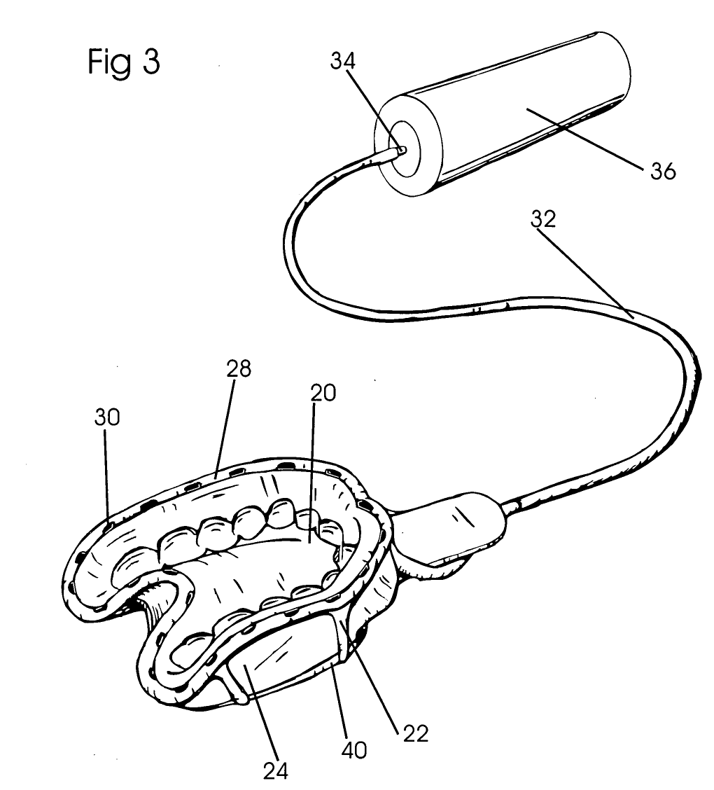

FIG. 3 is a perspective view showing sheet 20 after first, being molded to fit the shapes of the teeth, and second, being caused to be non-moldable when seated on the dental arch, and third, being removed from the mouth. Connector 22 is shown connecting sheet 20 to tray 24 and non-moldable filler 26. Ports 30 are shown along border 28. Extension 32 is connected to valve 34, and thence to vacuum 36.

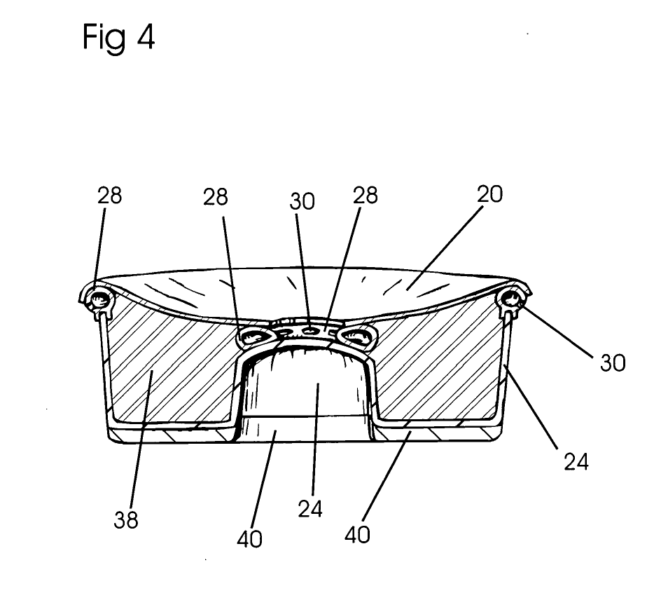

FIG. 4 is a cross-sectional view showing an additional embodiment, wherein sheet 20 and border 28 are connected to tray 24, tray 24 being filled with a moldable space filling material, moldable filler 38. It is preferred that sheet 20 is sealingly connected to border 28 and tray 24, so as to sealingly contain moldable filler 38, thereby inhibiting leakage of moldable filler 38 from tray 24 when tray 24 is forcefully seated onto a dental arch.

It is preferred that moldable filler 38 is comprised of a material which is provided moldable from the manufacturer, such as saline, silicone gel, wax, light-cured impression materials, air, or other plastically deformable materials. However, moldable filler 38 may be comprised of a material which is substantially non-moldable until said material is caused to be moldable by the operator, such as thermoplastic vinyl, and such.

It is further preferred that moldable filler 38 remain moldable after sheet 20 becomes molded to fit the shapes of the teeth. However, moldable filler 38 may be caused to be non-moldable after sheet 20 becomes molded to fit the shapes of the teeth.

It is preferred that filler 28 is comprised of a material having a high heat capacity, such that filler 28 can retain heat for an extended time, such as for use with heat activated medicaments, or to facilitate molding of sheet 20. However, filler 28 may have a low heat capacity, such as to affect the cooling time of moldable sheet 20. It is further preferred that filler 28 does not contain electrically conductive elements. However, filler 28 may contain electrically conductive elements, such as electrical conductors for connection to external electrical power sources, heating elements, and so on. Filler 28 may also contain exothermic or endothermic chemicals.

At the base of tray 24 is a seat, pad 40, for the teeth of the opposing arch to forcefully occlude against. Ports 30 are shown along border 28.

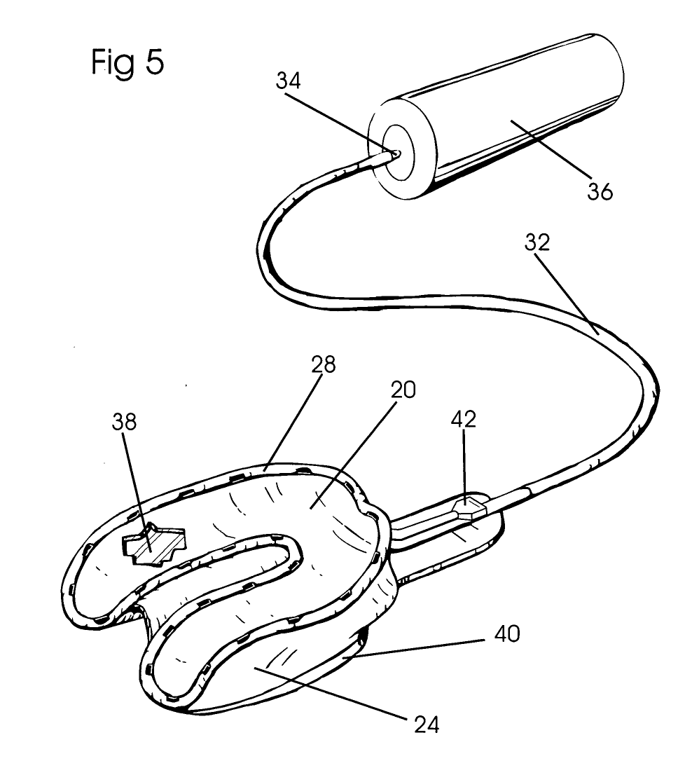

FIG. 5 shows a perspective view of sheet 20 and border 28 sealingly connected to tray 24, tray 24 being filled with moldable filler 38, such that moldable filler 28 is contained in tray 24 at least by sheet 20.

An electrical connector, socket 42, is shown at the anterior of tray 24 and sheet 20. It is preferred that socket 42 resealably contains a data storage chip for recording data from pressure-indicator elements of sheet 20. However, socket 42 may be a connection for any or all of the following: electrical power for heating elements in sheet 20 or in filler 28, electrical power for occlusal pressure indicators, data output amplification, data transmission, and so on. Also shown are ports 30, extension 32, valve 34, vacuum 36, and pad 40.

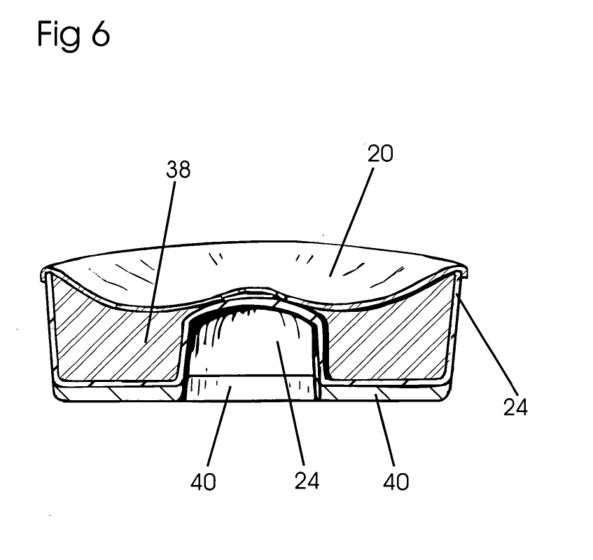

FIG. 6 shows a cross-sectional view of another embodiment, a cover, skin 44, wherein at least a portion of skin 44 is pliable, and skin 44 at least partly covers and contains moldable filler 38.

Skin 44 is sufficiently pliable such that it will conform to the shapes of the teeth when forcefully pressed onto the teeth, such as when sheet 20 is interposed between the teeth and skin 44. As such, when moldable filler 38 is plastically deformable, and when pressure is applied, skin 44 will conform to the shapes of the teeth.

It is preferred that skin 44 is substantially puncture resistant, resistant to stretching, resistant to wrinkling while conforming to the shapes of the teeth, and non-adherent to sheet 20 when sheet 20 is moldable. Materials which would be suitable for skin 44 include advanced polymers, such as those suitable for breast implant shells, as well as other materials. However, skin 44 may be somewhat stretchable, somewhat prone to wrinkling, and may be require the use of a separator, such as a lubricant gel to prevent adhesion to sheet 20.

Tray 24 is shown partly containing moldable filler 28, and pad 40 is on the surface of tray 24 which opposes the opposing arch of teeth.

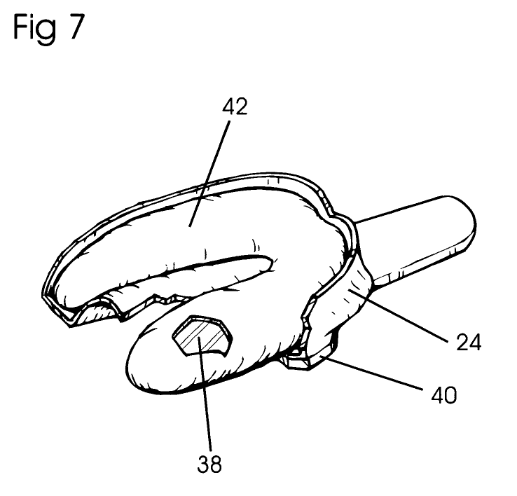

FIG. 7 shows a cutaway perspective view of an embodiment of skin 44 nested into tray 24, wherein skin 44 is configured to entirely contain moldable filler 38. As such, skin 44 forms a bladder having a U-shape which corresponds to the shape of a dental arch. In this embodiment, skin 44 may be removed from one tray 24 and placed into another tray 24, such as when tray 24 is sized or shaped for different dental arches.

It is preferred that the entirety of skin 44 is pliable. However, a portion of skin 44 may be substantially rigid, or skin 44 may contain a substantially rigid member, such that skin 44 may be pressed against a person's teeth utilizing fingers, without the use of tray 24, such as when sheet 20 is interposed between skin 44 and the teeth.

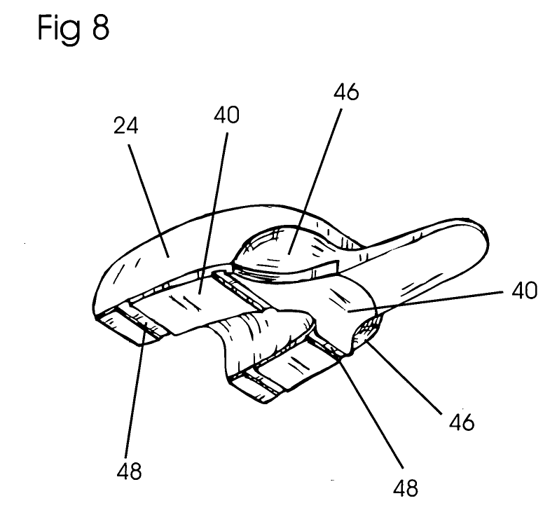

According to another aspect of the invention, there is provided a tray, tray 24, for use in the process of the invention, a typical embodiment of which is shown in perspective view FIG. 8. Tray 24 is comprised of an at least partly rigid dental tray and pad 40, a surface for the teeth of an opposing arch to forcefully occlude against, shown on the base of tray 24.

It is preferred that pad 40 is angled and configured so as to maximize the area of contact with the opposing teeth. Pad 40 is further angled and configured so as to maximize the muscular force a person's jaw can exert against pad 40, and therefore upon tray 24. It is preferred that pad 40 is wedge shaped, such that pad 40 has a greater thickness toward the anterior of tray 24, and a lesser thickness toward the posterior of tray 24. It is further preferred that at least the outer surface of pad 40 is comprised of an elastomeric material, to enhance comfort during forceful occlusion of the opposing teeth against pad 40, and to maximize the area of contact with the opposing teeth. As such, pad 40 facilitates forceful occlusion of the opposing teeth against tray 24, which facilitates forceful seating of tray 24 onto an arch of teeth.

It is preferred that tray 24 have a least one finger rest, rest 46, to facilitate further seating pressure of tray 24 onto an arch of teeth. It is preferred that a rest 46 is comprised of a depression in tray 24 and pad 40, and a buccal or facial protrusion of tray 24.

It is preferred that the surface of pad 40 is notched in at least one location, notch 48, such that at least one connector 22 may lay recessed within said notch, thereby stabilizing the position of connector 22, and reducing occlusal interference from connector 22.

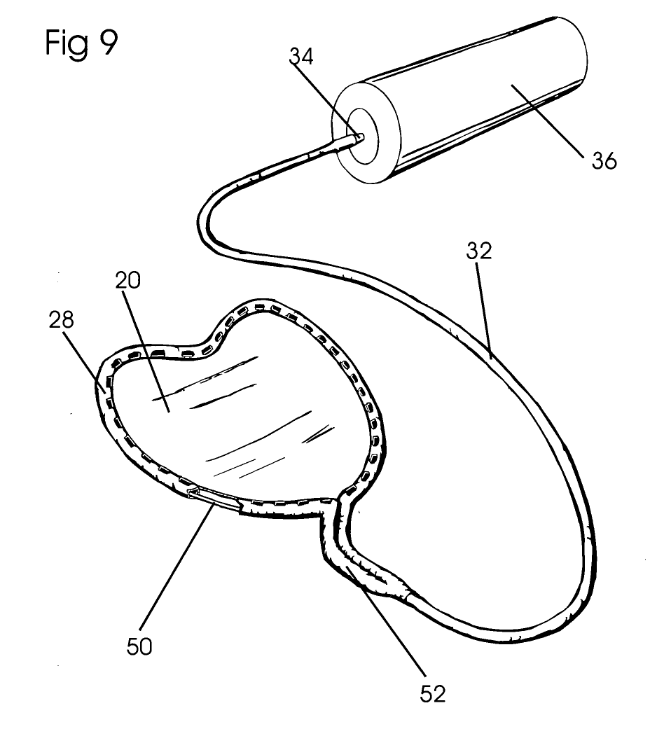

According to another aspect of the invention, there is provided a tray material for use in the process of the invention, a typical embodiment of which is shown in perspective cutaway view FIG. 9. Said tray material is comprised of sheet 20, border 28, ports 30, and an at least partly rigid frame, frame 50, wherein frame 50 is connected to at least a portion of the perimeter of sheet 20.

It is preferred that frame 50 lies within a lumen within border 28, along the perimeter of sheet 20. However, frame 50 may be connected to the exterior of border 28, or embedded within the perimeter of sheet 20, and so on.

It is preferred that various cross-sectional dimensions and configurations of border 28 are engineered to work with various cross-sectional dimensions and configurations of frame 50 so as to assist in positioning border 28 in the oral vestibule to enhance formation of a vacuum seal, and to assist with intraoral placement and removal of sheet 20. For example, at a given point along the length of border 28, frame 50 could provide support pressure along vectors in a first plane, while permitting free movement of border 28 along vectors in a second plane. At a different point along the length of border 28, frame 50 could provide support pressure along different vectors, and permit free movement along different vectors. In another example, frame 50 could exhibit deformation memory along a given portion of the length of border 28, yet be dead soft along a different portion of the length of border 28.

It is preferred that the anterior portion of frame 50 is connected to a handle, handle 52, to facilitate intraoral placement and removal of said tray material. It is further preferred that extension 32 is connected to border 28 at a point along the length of handle 52. FIG. 9 also shows extension 32 connected between border 28 and valve 34, and vacuum 36.

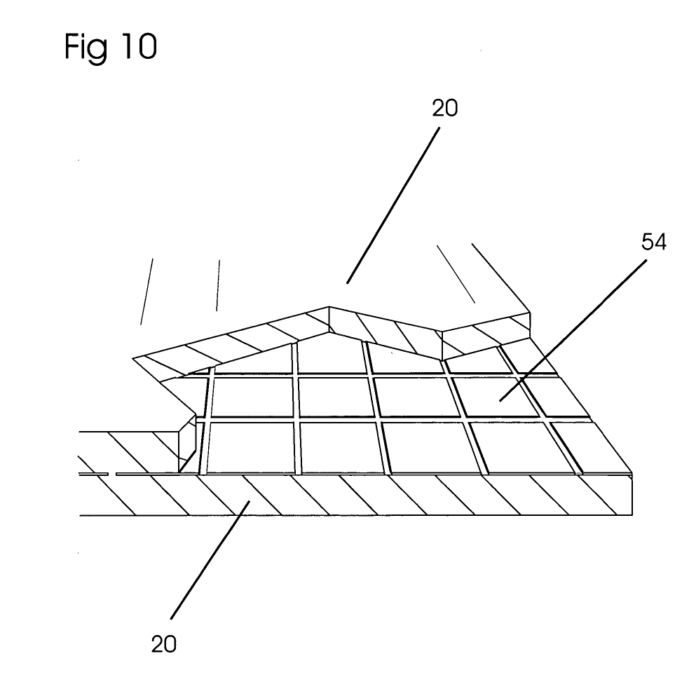

FIG. 10 is an enlarged perspective cutaway view of unmolded sheet 20 with a pressure indicating material, indicator 54. When a custom tray comprised of molded sheet 20 with indicator 54 is inserted between forcefully occluding dental arches, and the occlusal contacts of the teeth forcefully press against portions of said custom dental tray with indicator 54, then a record is produced. Said record therefore can indicate the location and area of occlusal contacts on said custom tray.

It is preferred that indicator 54 is comprised of a material that facilitates distinguishing relative pressure differences between multiple points of occlusal contact.

It is preferred that indicator 54 is embedded within the sheet 20 material. However, indicator 54 may be at least partly located on an external surface of sheet 20.

It is further preferred that indicator 54 is comprised of semi-conductive pressure-sensitive ink elements, such as pressure-sensitive ink which can output electrical signals regarding the location, duration, amplitude, and timing of occlusal contact pressure from forcefully occluding teeth on a custom dental tray comprised of sheet 20 with indicator 54.

However, indicator 54 may be comprised of other pressure-sensing electrical elements. Indicator 54 may also be comprised of other pressure sensitive non-electrical elements. For a first example, indicator 54 may also be comprised of PTFE embedded in sheet 20, wherein said PTFE is substantially opaque in appearance, such as a grid of small squares of PTFE, or even small particles of PTFE randomly dispersed in sheet 20 material. Occlusal pressure exerted on portions of opaque PTFE will cause said portions of opaque PTFE to become translucent. In addition, degrees of occlusal pressure exerted on opaque PTFE, can be correlated with degrees of translucency caused in opaque PTFE. As such, translucent portions of indicator 54 PTFE are visually distinguishable from the opaque portions of PTFE, and therefore can serve as records 58, indicating occlusal contact areas. In addition, occlusal contact pressures applied to indicator 54 PTFE cause greater translucency to form in areas of greater pressure, and lesser translucency to form in areas of lesser pressure.

For a second example, indicator 54 may be comprised of a half-thickness upper sheet 20, and a half-thickness lower sheet 20, wherein said upper sheet 20 is printed with a grid blue ink, and said lower sheet 20 is imprinted with a grid of yellow ink, such that when occlusal contact pressure is applied to sheet 20, the blue and yellow inks are pressed together to form a green record 58.

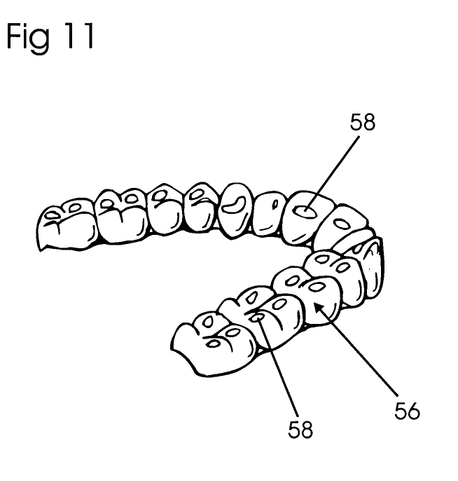

FIG. 11 shows a completed custom dental tray, custom tray 56, having indicator 54, after having been subjected to forceful occlusal contact pressures. Custom tray 56 has recorded occlusal contact pressures, record 58, which are shown as visually distinguishable.

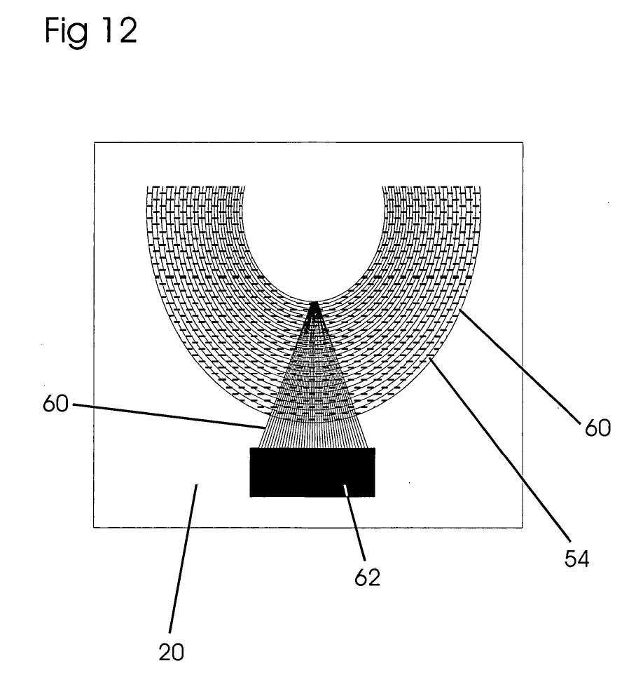

FIG. 12 shows a top view of an unmolded sheet 20 with multiple indicators 54 connected by circuits, circuits 60, to an electronic chip, chip 62. The drawing is not intended to be an electrical schematic, but rather a general plan for routing of circuits. Indicators 54 shown here are electrical or electromechanical pressure sensors. Chip 62 records electrical input data from indicators 54, such as data regarding the location, duration, amplitude, and timing of occlusal contact pressure exerted upon custom tray 56. Chip 62 is connectable to a data port, so that the data may be copied from chip 62. Chip 62 may also include a power source, Circuits 60 are arranged to follow the curvature of a dental-arch shape, thereby decreasing the likelihood that critical circuits 60 will be cut away when sheet 20 is trimmed to form custom tray 56, thereby cutting away peripheral circuits 60. In contrast, methods of fabricating occlusal pressure sensing appliances of the prior art do not include routine trimming of pressure indicators.

Circuits 60 are comprised of a material which will not significantly disrupt conductivity properties due to the process of molding sheet 20. It is preferred that circuits 60 are comprised of a non-elastic conductive material, such that the sheet 20 material surrounding circuits 60 undergo substantial plastic deformation during molding of sheet 20 to form custom tray 56, but not circuits 60 themselves. However, circuits 60 may be comprised of an elastic, stretchable conductive material.

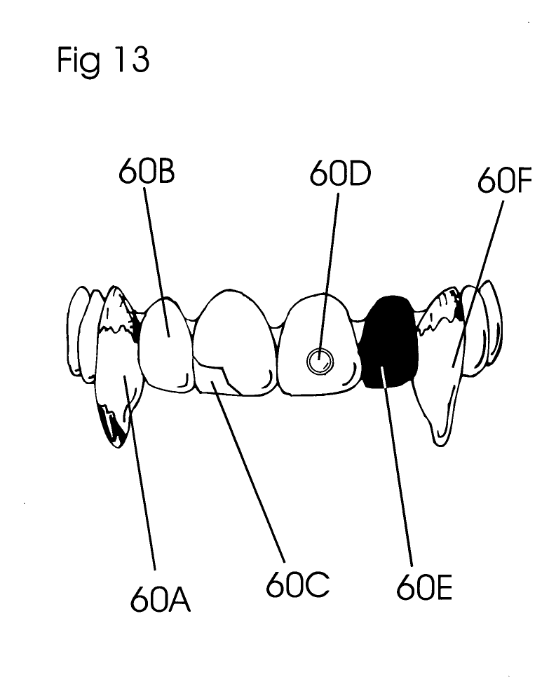

FIG. 13 shows a custom dental tray retaining attachments. It is preferred that said custom tray is molded with a space reserved for an attachment that is an occlusal pressure sensor. However, space may be reserved for other attachments, such as oral decorations. Attachments shown include a multiplicity of oral decorations, attachments 64A through 64F. Since custom trays 56 may readily be fabricated by persons unskilled in the art, custom trays may now be used for retaining oral decorations. Prior to the processes of the current invention, custom tray fabrication was generally too costly for routine use in retaining oral decorations.

For example of an oral decoration, attachment 64 may be comprised of a tooth-replacement material, wherein a tooth-colored material is placed against surfaces of custom tray 56 in a location where a tooth is missing, or a portion of a tooth is missing, thereby providing the appearance of a natural tooth. Other examples of oral decorations include electrically powered lights, light emitting substances, costume jewelry, colorations over the gingiva, tooth facings, and so on. Examples of tooth facings include a blackened facing which creates the appearance of a missing or broken tooth, a stained facing which creates an appearance of an uncleaned tooth, an unnaturally-shaped facing such as a fang shaped facing, a colored facing, a facing with an artistic image, and so on. Attachment 64 may also be comprised of an anchor which retains another attachment to custom tray 56.

For a spacer for a tooth-shaped attachment 64, it is preferred that the portion of said spacer which is to be oriented facing toward the anterior is substantially non-moldable, while the portion of the spacer which is to be oriented facing toward the gingiva or toward the opposing teeth is substantially moldable.

Attachments 64A and 64F show fang-shaped facings which appear to be stained and uncleaned. Attachment 64B shows a tooth replacement where a tooth is missing. Attachment 64C shows a tooth replacement, where a portion of a tooth is missing. Attachment 64D shows a decoration, such as a powered light source, or a jewel. Attachment 64E shows a black facing to mimic a missing tooth space.

It is preferred that a attachment 64 is located on an inner surface of custom tray 56, between custom tray 56 and the teeth or gingiva. However, attachment 64 may be located on an outer surface of custom tray 56, or even provided embedded within sheet 20. It is preferred that attachment 64 has retentive features to enhance retention against the surfaces of custom tray 56, such as undercuts, adhesives, and so on.

From the description above, a number of advantages of my dental tray material and process become evident:
(a) Accurately adapted dental trays can be made by persons unskilled in the art
(b) Accurately adapted dental trays can be made without the use of costly specialized equipment
(c) Accurately adapted dental trays can be made in a short time
(d) Dental trays can be made to record occlusal pressures
(e) Dental trays can be intraorally molded which are accurately adapted to the form of the teeth
(f) Dental trays can be intraorally molded which have substantial retention to the teeth
(g) Dental trays can be intraorally molded which have low fluid leakage
(h) Accurately adapted dental trays made by persons unskilled in the art can retain oral attachments

Another advantage is that accurately adapted custom dental trays can now be made by persons of the general public. In addition, they can be made rapidly and cost effectively in dental offices, or at home.

Operation—FIGS. 1-13

By using the dental tray material of the invention, it is now possible, surprisingly, to form an accurately conformed dental tray intraorally, without requiring costly equipment.

The process offers the advantage that the dental practitioner can now produce accurately adapted dental trays in a short time, such as trays which can record occlusal pressure. The process offers a further advantage that unskilled persons can now produce accurately adapted dental trays, such as in their own homes.

### EXAMPLE 1

Implementation of the process begins with selecting an appropriately sized tray 24 from a kit provided. Non-moldable filler 26 is prepared, such as by mixing premeasured base and catalyst components of a slow-setting putty dental impression material with the fingers to form a mixed dental impression material, loading said mixed dental impression material into tray 24, seating tray 24 with said mixed impression material onto the teeth until said mixed dental impression material is set, thereby forming a non-moldable filler 26. Tray 24 with non-moldable filler 26 is removed from the mouth.

A dental tray material provided comprises sheet 20 with indicator 54, connector 22, border 28, ports 30, and extension 32, as shown in FIG. 1. Indicator 54 is comprised of a grid of embedded PTFE squares. Said dental tray material is detachably mounted over non-moldable filler 26 and tray 24, such as by covering non-moldable filler 26 in tray 24 with sheet 20, and stretching connector 22 around the opposite side of tray 24 to stabilize the position of sheet 20, as shown in FIG. 2. Extension 32 is connected to valve 34 and vacuum 36.

Holding tray 24, the operator immerses said dental tray material, including sheet 20, non-moldable filler 26, and tray 24 into water heated to approximately 70° C., or until sheet 20 becomes substantially moldable, forming a moldable sheet 20. Tray 24, non-moldable filler 26, and said dental tray material with moldable sheet 20 are removed together from the heated water, and placed into a person's mouth. Non-moldable filler 26 and moldable sheet 20 are seated over the teeth by pressing firmly on tray 24 until very firm resistance is encountered. Moldable sheet 20 is now interposed between the teeth and non-moldable filler 26. Pressure from non-moldable filler 26 molds moldable sheet 20 to fit the shapes of the teeth.

Valve 28 is opened, permitting undesirable air and fluids to be forcefully suctioned from between moldable sheet 20 and the teeth and gingiva, and in through border 28 and extension 32, drawing moldable sheet 20 further into the detailed spaces about the teeth and gingiva.

Moldable sheet 20 is permitted to cool sufficiently to become non-moldable, thereby forming a molded sheet 20. Tray 24 with non-moldable filler 26 and said dental tray material with molded sheet 20 are removed from the mouth, as shown in FIG. 3. Extension 30 is disconnected from valve 28. Connector 22 is cut with shears. Molded sheet 20 is pulled free from non-moldable filler 26. Molded sheet 20 of said dental tray material is trimmed with shears to form a completed custom dental tray, custom tray 56, as shown in FIG. 11.

Custom tray 56 is inserted into a patient's mouth. The dental arches are occluded forcefully, such that occlusal contact points of the teeth apply pressure to custom tray 56. Indicator 54 PTFE is compressed by the occlusal contact points, thereby rendering the indicator 54 PTFE substantially translucent at the location of the occlusal contact points. The translucent PTFE areas are visually distinguishable from the surrounding opaque PTFE, and can therefore serve as translucent recordings, records 58. As such, the occlusal contact points are visually recorded as records 58 in custom tray 56.

Records 58 may be used to quantify parafunctional pressures to help patients recognize the associated risks. In addition, the data may be useful for assessing occlusal discrepancies, or may be useful for assessment of parafunctional jaw movements during sleep

### EXAMPLE 2

Implementation of the process begins with selecting an appropriately sized tray 24 from a kit, wherein tray 24 has the following connected elements thereon: sheet 20 with indicators 54, border 28, ports 30, extension 32, filler 28, pad 40, and socket 42, as shown in FIG. 5. Indicators 54 are connected to socket 42 by circuits 60.

Extension 32 is connected to valve 34 on a vacuum 36 that is provided. Tray 24, with said connected elements, is immersed into water heated to approximately 70° C., or until sheet 20 becomes substantially moldable, forming a moldable sheet 20.

Tray 24 and moldable sheet 20 with said connected elements are removed from the heated water, and placed into a person's mouth. Tray 24 with said moldable sheet 20 is forcefully seated over the teeth by pressing firmly on tray 24 until very firm resistance is encountered. Moldable sheet 20 is now interposed between the teeth and moldable filler 38.

The opposing arch of teeth are forcefully clenched down onto pad 40, to provide seating pressure of tray 24 against moldable filler 38, moldable sheet 20 and the teeth. Additional seating pressure is created by finger pressure against rest 46 areas. Substantial seating pressure against tray 24 is transferred to moldable filler 38, and thence to moldable sheet 20, causing moldable sheet 20 to become molded to the shapes of the teeth.

The seating pressure tends to cause border 28 to be pressed against the vestibular mucosa. As such, border 28 acts as a cushion between the rigid walls of tray 24 and the sensitive mucosa, and border 28 tends to form a somewhat airtight seal. Valve 34 is opened, and the negative pressure vacuum in vacuum 36 forcefully suctions undesirable air and fluids from between moldable sheet 20 and the teeth and gingiva, and forcefully drawing moldable sheet 20 further into the detailed spaces about the teeth and gingiva.

Moldable sheet 20 is permitted to cool sufficiently to become non-moldable, thereby forming a molded sheet 20. Tray 24 with molded sheet 20 and connected elements are removed from the mouth. Molded sheet 20 is cut free from tray 24, such as by cutting with shears or a blade about the entire perimeter of molded sheet 20. Residual moldable filler 38 is cleaned from the surfaces of molded sheet 20. Molded sheet 20 is trimmed with shears to form a completed custom dental tray, custom tray 56.

Custom tray 56 is inserted into a patient's mouth during a test session, such as during sleep, or during an analysis of occlusion. The dental arches are occluded forcefully, such that occlusal contact points of the teeth apply pressure to custom tray 56. The pressure sensitive ink of indicators 54 is compressed by the occlusal contact points, thereby causing electrical signals to be generated by said ink. Said electrical signals are conducted by circuits 60 to socket 42, where said electrical signals are recorded in a removable data collection chip. If signal amplification is necessary for signals to be recordable in said chip, then a power source and amplifier would also be provided. Said chip is capable of recording data regarding location, duration, amplitude and timing of occlusal pressure.

After the test session is complete, said chip is removed from socket 42, and connected to a standard computer input port, either directly, or using an adaptor. Data contained in said chip is copied from said chip into the computer, where it may be saved or transmitted to a remote computer for analysis. Such data may be used to quantify parafunctional pressures to help patients recognize the associated risks. In addition, the data may be useful for assessing occlusal discrepancies, or may be useful for assessment of parafunctional jaw movements during sleep

### EXAMPLE 3

Implementation of the process begins with selecting an appropriately sized tray 24 from a kit provided, wherein tray 24 has the following elements thereon: filler 28, skin 44, and pad 40, as shown in FIG. 6.

An ingestible spacer for an attachment 64, wherein the shape of said spacer is similar to attachment 64, is adhered to the surface of a tooth or gingiva using a temporary adhesive paste. Said spacer has retentive undercut features to enhance retention to custom tray 56.

A dental tray material, comprising sheet 20, connector 22, border 28, ports 30, and extension 32, is detachably mounted over skin 44 and tray 24 by covering skin 44 on tray 24 with sheet 20, and stretching connector 22 around the opposite side of tray 24 to stabilize the position of sheet 20. Extension 32 is connected to valve 34 and vacuum 36.

Tray 24 with said dental tray material is immersed into water heated to approximately 70° C., or until sheet 20 becomes substantially moldable, forming a moldable sheet 20.

Tray 24 with said dental tray material with a moldable sheet 20 is removed from the heated water, and placed into a person's mouth. Tray 24 with said moldable sheet 20 is forcefully seated over the teeth by pressing firmly on tray 24 until very firm resistance is encountered. Moldable sheet 20 is now interposed between the teeth and skin 44.

The opposing arch of teeth is forcefully clenched down onto pad 40, to provide seating pressure of tray 24 against moldable filler 38 and skin 44, and skin 44 against moldable sheet 20, and moldable sheet 20 against the teeth. Additional seating pressure is created by finger pressure against rest 46 areas. The seating pressure against moldable sheet 20 causes moldable sheet 20 to become molded to the shapes of the teeth.

The seating pressure tends to cause border 28 to be pressed against the vestibular mucosa. As such, border 28 acts as a cushion between the rigid walls of tray 24 and the sensitive mucosa, and border 28 tends to form a somewhat airtight seal. Valve 34 is opened, and the negative pressure vacuum in vacuum 36 forcefully suctions undesirable air and fluids from between moldable sheet 20 and the teeth and gingiva, and forcefully drawing moldable sheet 20 further into the detailed spaces about the teeth and gingiva. Said spacer for attachment 64 reserves a space for attachment 64 about the teeth or gingiva, forming a reserved space having retentive undercut features.

Moldable sheet 20 is permitted to cool sufficiently to become non-moldable, thereby forming a molded sheet 20. Tray 24, said dental tray material with molded sheet 20, and said spacer are removed from the mouth. Molded sheet 20 is cut free from tray 24, such as by cutting with shears or a blade about the perimeter of molded sheet 20. Molded sheet 20 is trimmed with shears to form a completed custom dental tray, custom tray 56.

Said spacer for attachment 64 is removed from said reserved space in custom tray 56, such as by working said spacer free from retentive undercut features. An adhesive is placed into custom tray 56, to enhance retention of attachment 64. Attachment 64 is inserted into said reserved space in custom tray 56, and engaged into said retentive undercut features, as shown in FIG. 13. Custom tray 56 is placed over the teeth with attachment 64 retained in the desired location. Tray 24 with skin 44 containing moldable filler 38 may be reused.

### EXAMPLE 4

Implementation of the process begins with selecting from a kit providing an appropriately sized custom dental tray material comprising sheet 20, border 28, ports 30, extension 32, frame 50, and handle 52, as shown in FIG. 9. Vacuum 36 is removed from the kit, and valve 34 is connected to extension 32.

The dental tray material is immersed in water heated to approximately 75° C., or until sheet 20 becomes substantially moldable. Said dental tray material with moldable sheet 20 is removed from the heated water, and inserted into a person's mouth. Holding handle 52, the operator seats border 28 fully into the mucosal vestibule about the dental arch, facilitated by the rigidity of frame 50. Moldable sheet 20 is thereby stretched over the teeth.

The teeth are gently occluded onto the dental tray material, to begin molding the occlusal surface of the dental tray material. Valve 34 is opened, and negative pressure vacuum from vacuum 36 forcefully suctions air and fluids from between moldable sheet 20 and the teeth and gingiva, and forcefully draws moldable sheet 20 into the detailed spaces about the teeth and gingiva. Moldable sheet 20 is thereby molded to fit the shapes of the teeth. Moldable sheet 20 is permitted to cool, and become non-moldable, forming a molded dental tray material with a molded sheet 20.

Said dental tray material with molded sheet 20 is removed from the mouth. Extension 32 is disconnected from valve 34. Molded sheet 20 is trimmed with shears to form a completed custom dental tray, custom tray 56.

An amount of medicament is placed into custom tray 56, and placed into the mouth for a desired time period, after which custom tray 56 is removed from the mouth.

Summary, Ramifications and Scope

Accordingly, the reader will see that the dental tray material of this invention permits formation of accurately adapted custom dental trays to be formed intraorally in a short amount of time, and without the need for costly equipment. Furthermore, the dental tray material and process has the additional advantages in that it permits formation of accurate trays which can record occlusal pressures.

Although the description above contains many specificities, these should not be construed as limiting the scope of the invention and process, but as merely providing illustrations of some of the presently preferred embodiments of this invention.

For example, a dental practitioner may elect to utilize a custom dental tray material and process of the invention to eliminate having to form models of the teeth, despite having a custom tray vacuum former.

As a second example, a dental practitioner not having a custom tray vacuum former may elect to use a custom dental tray material and process of the invention, but substitute using models of the teeth instead of the patient's teeth as a template for molding sheet 20.

As a third example, a dental practitioner may elect to use the process partially, such as by connecting extension 32 to the office vacuum system, rather than utilize vacuum 36.

As a fourth example, an oral suction orifice may be connected to border 28 to permit the user to utilize forceful inhalation of air to create negative air pressure within border 28.

As a fifth example, skin 44 with moldable filler 38 may be used as a custom tray with or without the use of sheet 20 or tray 24, such as when a medicament is interposed between skin 44 and a person's teeth, and moldable filler 38 is heated to accelerate the rate of activity of said medicament.

As a sixth example, a dental practitioner may use a vacuum former and models of teeth to form a custom tray 56 capable of indicating and recording occlusal pressures from sheet 20 with indicators 54, circuits 60 and chip 62.

Thus the scope of the invention should be determined by the appended claims and their legal equivalents, rather than by the examples given.

I claim:

1. A process for forming a custom dental tray comprising the steps of: making a substantially accurate imprint of a person's teeth, providing a tray material at least a portion of which comprises a moldable sheet, interposing said moldable sheet between said imprint and the teeth, forcefully seating said imprint onto the teeth such that interposed said moldable sheet is molded to fit the shapes of the teeth, causing said moldable sheet to become substantially non-moldable to form a molded tray material, removing said imprint and said molded tray material from the teeth, removing said molded tray material from said imprint, and trimming said molded tray material to form a custom dental tray.

2. The process in claim 1, wherein said tray material is caused to be substantially moldable by heating.

3. The process in claim 1, wherein said tray material is detachably connected to said imprint, or to a dental tray containing said imprint.

4. The process in claim 1, wherein at least one occlusal pressure indicator is associated with said custom dental tray.

5. The process in claim 1, wherein an attachment is associated with said custom dental tray.

6. A process for forming a custom dental tray comprising the steps of: making an imprint of a person's teeth, providing a tray material at least a portion of which comprises a moldable sheet, interposing said moldable sheet between said imprint and the teeth, forcefully seating said imprint onto the teeth such that interposed said moldable sheet is molded to fit the shapes of the teeth, causing said moldable sheet to become substantially non-moldable to form a molded tray material, removing said imprint and said molded tray material from the teeth, removing said molded tray material from said imprint, and trimming said molded tray material to form a custom dental tray.

7. The process in claim 6, wherein said tray material is detachably connected to said imprint, or to a dental tray containing said imprint.

8. The process in claim 6, wherein at least one occlusal pressure indicator is associated with said custom dental tray.

9. The process in claim 6, wherein an attachment is associated with said custom dental tray.

10. A process for forming custom dental trays comprising the steps of: providing a tray material at least a portion of which comprises a moldable sheet, providing a moldable space filling material, interposing said tray material between said moldable space filling material and a person's teeth, forcefully seating said moldable space filling material over said tray material such that said tray material is molded to fit the shapes of the teeth, causing said tray material to become substantially non-moldable to form a molded tray material, removing said molded tray material from the teeth and from said moldable space filling material, and trimming said molded tray material to form a custom dental tray.

11. The process in claim 10, wherein a dental tray at least partly contains said moldable space filling material, and where at least a portion of said tray is substantially rigid.

12. The process in claim 10, wherein at least one occlusal pressure indicator is associated with said custom dental tray.

13. The process in claim 10, wherein an attachment is associated with said custom dental tray.

14. A process for forming custom dental trays comprising the steps of: providing a dental tray material at least a portion of which comprises a moldable sheet having a vacuum tube about the perimeter of said moldable sheet, covering a person's teeth with said moldable sheet, applying a vacuum to said vacuum tube, such that air and fluids are forcefully removed from between said moldable sheet and the teeth and gingiva, and such that said moldable sheet is molded to fit the shapes of the teeth, causing said moldable sheet to be substantially non-moldable to form substantially non-moldable sheet, removing said non-moldable sheet from the teeth, and trimming said molded tray material to form a custom dental tray.

15. The process in claim 14, wherein said moldable sheet is interposed between the teeth and an imprint of the teeth.

16. A custom dental tray material having at least one occlusal pressure indicating means, such that pressure exerted by teeth on a custom dental tray comprised of said custom dental tray material will cause an indication of said occlusal pressure.

17. The custom dental tray material of claim 16, wherein said pressure indicating means is pressure sensitive ink.

18. The custom dental tray material of claim 16, wherein said occlusal pressure indicating means is capable of obtaining a variation in electrical resistance with a variation in pressure applied to portions said custom dental tray.

19. The custom dental tray material of claim 16, wherein said pressure indicating means is connected to an electronic recording means.

20. A custom dental tray material comprised of a sheet of dental tray material connected to at least one connector, said connector for detachably attaching said sheet to a dental imprint, or to a tray containing said imprint.
